(19) United States
(12) Patent Application Publication
(10) Pub. No.: US 2013/0275302 A1
(43) Pub. Date: Oct. 17, 2013

(54) ELECTRONIC CHEQUE METHOD AND SYSTEM

(71) Applicants: Eng Sia Lee, Penang (MY); Jin Feei Loh, Petaling Jaya (MY)

(72) Inventors: Eng Sia Lee, Penang (MY); Jin Feei Loh, Petaling Jaya (MY)

(21) Appl. No.: 13/997,551

(22) PCT Filed: Dec. 21, 2011
(86) PCT No.: PCT/MY11/00243

§ 371 Date: Jun. 24, 2013

(30) Foreign Application Priority Data
Dec. 24, 2010 (MY) PI2010006215

(51) Int. Cl. G06Q 20/10

(52) U.S. Cl. CPC G06Q 20/108
USPC 705/42

(57) ABSTRACT

An electronic cheque method is disclosed whereby a cheque issuing server receives an electronic cheque request from a machine of an issuer. The cheque issuing server issues the electronic cheque and allocates and applies a unique cheque code to the electronic cheque to identify the electronic cheque. The cheque issuing server advises a machine of a recipient of required data of the electronic cheque. The required data includes the unique cheque code. The cheque issuing server receives from the machine of the recipient a claim for credit of the electronic cheque amount, the claim being by reference to the unique cheque code.

### TECHNICAL FIELD

This invention relates to an electronic payment method and system and refers particularly, though not exclusively, to an electronic cheque method and system.

### BACKGROUND

Traditionally, cheques are governed by legislation such as, for example, a Bill of Exchange Act (BOEA) or equivalents thereto, depending on the country concerned. Essentially, the BOEA makes cheques into a form of a promissory note. An electronic cheque, however, may not be included within the BOEA as it was enacted many years ago and well before the information age.

There are many so-called eCheque schemes currently in existence. Most require the physical printing of cheques which are then sent or mailed to recipients.

### SUMMARY

According to an exemplary aspect there is provided an electronic cheque method comprising: a cheque issuing server receiving an electronic cheque request from a machine of an issuer, the cheque issuing server issuing the electronic cheque and allocating and applying a unique cheque code to the electronic cheque to identify the electronic cheque; the cheque issuing server advising a machine of a recipient of required data of the electronic cheque, the required data comprising the unique cheque code the cheque issuing server receiving from the machine of the recipient a claim for credit of the electronic cheque amount, the claim being by reference to the unique cheque code.

According to another exemplary aspect there is provided an electronic cheque method comprising: a machine of a recipient receiving required data of an electronic cheque from a cheque issuing server, the required data comprising a unique cheque cede; the unique cheque code having been applied to the electronic cheque by the cheque issuing server to identify the electronic cheque; the electronic cheque having been issued by the cheque issuing server in consequence of the cheque issuing server having received an electronic cheque request from a machine of an issuer, the cheque issuing server subsequently receiving from the machine of the recipient a claim for credit of the electronic cheque amount, the claim being by reference to the unique cheque code.

According to a further exemplary embodiment there is provided an electronic cheque system comprising: a cheque issuing server configured to receive an electronic cheque request from a machine of an issuer, the cheque issuing server also being configured to issue the electronic cheque and allocating and applying a unique cheque code to the electronic cheque to identify the electronic cheque; the cheque issuing server further being configured to advise a machine of a recipient of required data of the electronic cheque, the required data comprising the unique cheque code; the cheque issuing server additionally being configured to receive from the machine of the recipient a claim for credit of the electronic cheque amount, the claim being by reference to the unique cheque code.

The electronic cheque request may comprise prescribed minimum data. The prescribed minimum data may comprise at least one of: a name of the recipient, the date, the amount of the electronic cheque, a number of a mobile ‘phone of the recipient, and basic details of the account of the issuer at the bank on which the electronic cheque is to be drawn. The required data may further comprise the amount of the electronic cheque, a name of the issuer, and the electronic cheque date. Prior to advising the machine of recipient of the required data, the cheque issuing server may send to the machine of the issuer full details of the electronic cheque for confirmation. The required data may be sent by the cheque issuing server after receipt by the cheque issuing server of confirmation from the machine of the issuer. The full details of the electronic cheque may comprise at least one of: the date of the electronic cheque, the amount of the electronic cheque, the unique cheque code, the name of the recipient, the mobile ‘phone number of the recipient, and basic details of the account of the issuer at the bank on which the electronic cheque is to be drawn.

The claim may further comprise details of an account of the recipient into which the electronic cheque amount is to be credited. After receiving the claim, the cheque issuing server may submits the electronic cheque for clearance. After clearance, it may credit the account with the electronic cheque amount.

The cheque issuing server may store data relating to the electronic cheque in folders of the issuer, the recipient and the issuing bank. The issuer may have access to data stored in the issuer's folder. The recipient may have access to data stored in the recipient's folder The issuing bank may have access to date stored in the issuing bank's folder.

The prescribed minimum data may further comprise terms and conditions specified by the issuer. The terms and conditions may form part of the full details. The terms and conditions may form part of the required details.

### BRIEF DESCRIPTION OF THE DRAWINGS

In order that the invention may be fully understood and readily put into practical effect there shall now be described by way of non-limitative example only exemplary embodiments, the description being with reference to the accompanying illustrative drawings.

In the drawings:

FIG. 1 is an overall block diagram illustrating the parties and their relationships in an exemplary embodiment; and

FIG. 2 is a flow chart illustrating the process flow for the exemplary embodiment of FIG. 1.

### DETAILED DESCRIPTION OF THE EXEMPLARY EMBODIMENTS

Electronic cheques may be issued by the use of Internet banking or by use of cellular/mobile/hand telephones (“mobile ‘phones”), particularly those with Internet connectivity. The electronic cheques may be issued singularly, or in batches. It is easier to issue electronic cheques in batches by use of the Internet than over a telephone network to mobile ‘phones.

Electronic cheques is to be taken as including all forms of electronic cheques including, but not limited to, electronic cheques, electronic bank cheques, and electronic travellers cheques.

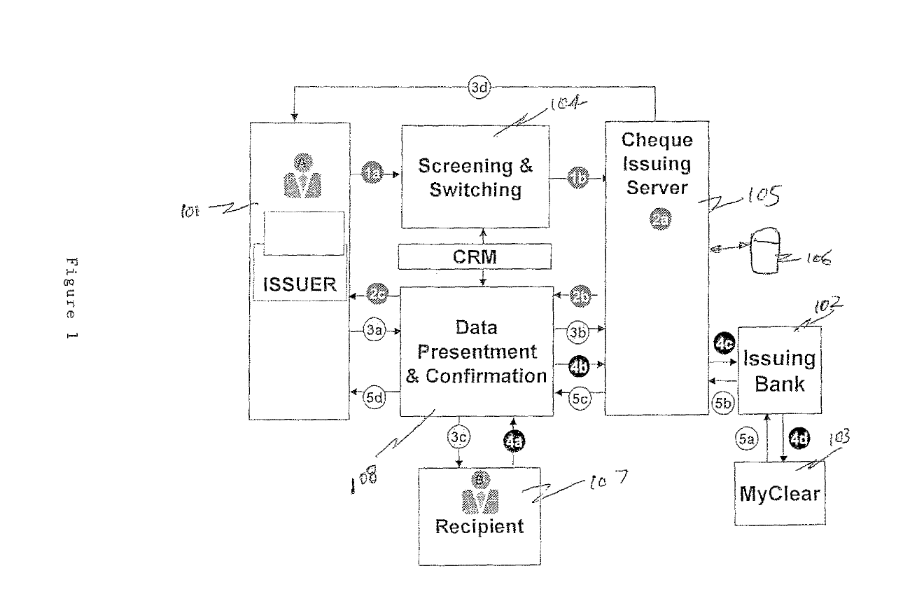

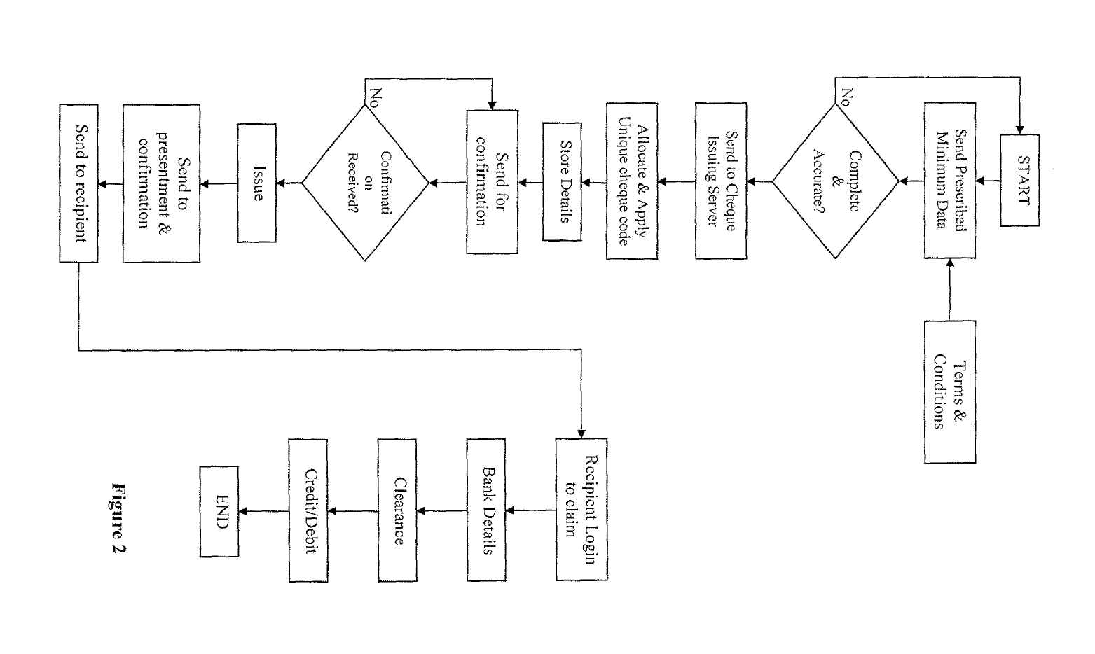

As shown in FIGS. 1 and 2, there is a machine 101 of an issuer, the issuer being a customer of an issuing bank 102 having a server 103. When an electronic cheque is to issue, after an appropriate login procedure, prescribed minimum data is sent from the machine 101 to an electronic cheque screening and switching server 104. The prescribed minimum data may be, for example, the name of the recipient, the date, the amount of the electronic cheque and a number of a mobile ‘phone of the recipient. It may also include the basic details of the account of the issuer at the bank 102 on which the electronic cheque is to be drawn. For a corporate recipient, the number of the mobile ‘phone may be eliminated, or may be the number of a mobile ‘phone of an authorised officer of the recipient. The electronic cheque may be drawn on a dedicated cheque account of the issuer at bank 102, or any other account of the issuer at bank 102.

The prescribed minimum data may optionally include terms and conditions as specified by the issuer. Standard terms and conditions may include, for example, that the electronic cheque is for the account of the payee only, not payable to bearer, post-dating of the electronic cheque, and so forth. All conditions are preferably able to be applied by and monitored for compliance electronically. The applying and/or monitoring may be by the cheque issuing server 105.

The electronic cheque screening and switching server 104 initially screens the prescribed minimum data to ensure completeness and accuracy. If not complete and accurate, the electronic cheque screening and switching server 104 refers the problem back to the issuer machine 101. If complete and accurate, the electronic cheque screening and switching server 104 passes the request to the cheque issuing server 105 where the server 105 allocates each electronic cheque with a unique cheque code that serves as a reference code to uniquely identify each electronic cheque. The unique cheque code may be numeric, alpha, or alpha-numeric. The electronic cheque details, including the code allocated are stored in the database 106 of the server 105 under folders for the issuer, the recipient, and the issuing bank 102.

The cheque issuing server 105 then sends a message to the machine 101 of the issuer containing full details of the electronic cheque and awaits a confirmation from the machine 101. Upon receipt of that confirmation, or after correction and confirmation, the electronic cheque issues. The confirmation process may be via a data presentment and confirmation server 108. When the electronic cheque issues the server 105 applies the unique cheque code, and optionally may also apply a digital signature, to the electronic cheque. The full details of the electronic cheque may include: the date of the electronic cheque, the amount of the electronic cheque, the unique cheque code, the name of the recipient, and the mobile ‘phone number of the recipient. They may also include basic details of the account of the issuer at the bank 102 on which the electronic cheque is to be drawn.

As soon as the electronic cheque issues by the server 105, the required data in relation to the electronic cheque is sent from the server 105 to the data presentment and confirmation server 108 that operates in a generally similar manner to the server 104, and then to the recipient's machine 107. The recipient's machine may be a mobile ‘phone, or a computer of any suitable form. The notification may be by using any suitable text message such as, for example SMS or email, or a traditional communication channel such as verbally. The required data includes the unique cheque code, cheque amount, cheque date and the name of the issuer. It may include other data as required or desired.

If any conditions form part of the prescribed information, they are checked by the server for compliance at this time. They may also form part of the full details of the electronic cheque sent by server 105 to machine 101 and/or part of the required data sent by the server 105 to machine 107.

With the unique cheque number, the recipient's machine 107 can then log in to the server 105 by use of the unique cheque code. The details of the bank account into which the electronic cheque is to be deposited are then provided to the server 105 by the recipient's machine 107. This may be when and as required by the recipient. As all electronic cheques are issued by and stored at the server 105, the recipient may claim the cheque at their leisure, and the monies are only then transferred directly into the recipient's nominated account.

After the claim is filed at the server 105 by the machine 107, the server 105 presents the electronic cheque to the server 103 for clearance. Upon clearance being provided, the server 105 can authorize the release of the funds into the account nominated by the recipient.

The server 103 may be associated with an Automated Clearing House (“ACH”) (not shown). The ACH debits the bank account of the issuer (101) and credits the recipient's (107) bank account. The bank account of the recipient (107) may reside in another bank (i.e. not the same bank as the issuing bank (102)). The cheque issuing server 105 usually resides with the issuing bank (102) which means each issuing bank would have its own cheque issuing server. This may change in practice.

The cheque dishonour process is that when the recipient redeems the cheque subjected to the cheque date (for example, the electronic cheque may be post-dated); the cheque issuing server (105) determines if the issuer's bank account has enough funds. If so, only then does the cheque issuing server instruct the ACH server (103) to do the necessary debiting and crediting. If there are insufficient funds, the machines 101, 107 of both the issuer and recipient are notified accordingly.

The user may have access to data in the user's folder in the database 106; the recipient may have access to the data in the recipient's folder in the database 106; and the bank 102 may have access to the data in the bank's folder in the database 106. This may be for all data, or a restricted list of data. Each party has access to their own folder and none other. This may be used for account management, auditing and/or taxation purposes.

As the system is digital in nature and it eliminates inconvenience, mistakes and nearly all the costs associated with physical cheques. It's also designed to be user friendly and cost friendly to the business community, in particular the cash flow management and habit of having paper trail and filing. It can also speed the process of clearing of cheques to enable the recipient to have access to the funds at an earlier time.

For corporate customers, there may be usually three persons within the organization that play the role of “Data Entry”, “Approval 1” and “Approval 2”. For “Data Entry”, it is usually a clerk who generates a list of payments to be made based on invoices. This list can be uploaded to the Internet banking website of the bank. “Approval 1” and “Approval 2” may be finance managers who will go through and verify the list and provide approval.

For security, usually a two-factor authentication process is used. This may mean that in addition to the usual username-password combination, another security token is used to generate an independent PIN for the final approval process. There are many variants of two-factor authentication.

For the use of mobile ‘phones, electronic cheques may issue by the use of an SMS, MMS, email or other form of text message. This is useful especially for individuals or people on the move. An example SMS could be: “CHEQUE $512.50 25-10-2010 JOHN SMITH+65-98981234” where “CHEQUE” is the SMS keyword, $512.20 the amount, 25-10-2010″ the date, “JOHN SMITH” the recipient's name and “+65-98981234” the recipient's mobile ‘phone number. The server may then request the user to confirm this instruction via a reply SMS. Confirmation may be by using a missed call or another text message.

Alternatively for better security, a Java applet may be installed on the mobile, phone for electronic cheque issuance so that the communication with the server may be digitally secured via encryption. For example, to run the Java applet, the user may be required to enter a PIN code.

Additional two-factor authentication may also be used for electronic cheque issuance via mobile ‘phones.

Whilst the foregoing description has described exemplary embodiments, it will be understood by those skilled in the technology concerned that many variations in details of design, construction and/or operation may be made without departing from the present invention.

1. An electronic cheque method comprising:
a cheque issuing server, residing within an issuing bank, receiving an electronic cheque request from a machine of an issuer,
the cheque issuing server issuing the electronic cheque and allocating and applying a unique cheque code to the electronic cheque to identify the electronic cheque;
the cheque issuing server advising a machine of a recipient of required data of the electronic cheque, the required data comprising the unique cheque code;
the cheque issuing server receiving from the machine of the recipient a claim for credit of the electronic cheque amount, the claim being by reference to the unique cheque code;
the claim further comprising details of an account of the recipient into which the electronic cheque amount is to be credited;
wherein after receiving the claim, the cheque issuing server submits the electronic cheque for clearance to an automated clearance house and, upon clearance, a bank account of the issuer is debited and a bank account of the recipient is credited with the electronic cheque amount.

2. An electronic cheque method as claimed in claim 1, wherein the electronic cheque request comprises prescribed minimum data, the prescribed minimum data comprising at least one selected from the group consisting of: a name of the recipient, the date, the amount of the electronic cheque, a number of a mobile ‘phone of the recipient, and basic details of the account of the issuer at the bank on which the electronic cheque is to be drawn.

3. An electronic cheque method as claimed in claim 1, wherein the required data further comprises: the amount of the electronic cheque, a name of the issuer, and the electronic cheque date.

4. An electronic cheque method as claimed in claim 1, wherein prior to advising the machine of recipient of the required data, the cheque issuing server sends to the machine of the issuer full details of the electronic cheque for confirmation, the required data being sent by the cheque issuing server after receipt by the cheque issuing server of confirmation from the machine of the issuer.

5. An electronic cheque method as claimed in claim 4, wherein the full details of the electronic cheque comprise at least one selected from the group consisting of: the date of the electronic cheque, the amount of the electronic cheque, the unique cheque code, the name of the recipient, the mobile ‘phone number of the recipient, and basic details of the account of the issuer at the bank on which the electronic cheque is to be drawn.

6. An electronic cheque method as claimed in claim 1, wherein the cheque issuing server stores data relating to the electronic cheque in folders of the issuer, the recipient and the issuing bank.

7. An electronic cheque method as claimed in claim 6, wherein the issuer has access to data stored in the issuer's folder; the recipient has access to data stored in the recipient's folder; and the issuing bank has access to date stored in the issuing bank's folder.

8. An electronic cheque method as claimed in claim 2, wherein the prescribed minimum data further comprises terms and conditions specified by the issuer.

9. An electronic cheque as claimed in claim 8, wherein the terms and conditions form part of the full details.

10. An electronic cheque as claimed in claim 8, wherein the terms and conditions form part of the required details.

11. An electronic cheque method comprising:
a machine of a recipient receiving required data of an electronic cheque from a cheque issuing server residing within an issuing bank, the required data comprising a unique cheque code;
the unique cheque code having been applied to the electronic cheque by the cheque issuing server to identify the electronic cheque;
the electronic cheque having been issued by the cheque issuing server in consequence of the cheque issuing server having received an electronic cheque request from a machine of an issuer,
the cheque issuing server subsequently receiving from the machine of the recipient a claim for credit of the electronic cheque amount, the claim being by reference to the unique cheque code
the claim further comprising details of an account of the recipient into which the electronic cheque amount is to be credited;
wherein the cheque issuing server submits the electronic cheque for clearance to an automated clearance house after receiving the claim, and, upon clearance, a bank account of the issuer is debited and a bank account of the recipient is credited with the electronic cheque amount.

12. An electronic cheque method as claimed in claim 11, wherein the cheque issuing server issues the electronic cheque after receiving prescribed minimum data from a machine of an issuer, the prescribed minimum data comprising at least one selected from the group consisting of: a name of the recipient, the date, the amount of the electronic cheque, a number of a mobile ‘phone of the recipient, and basic details of the account of the issuer at the bank on which the electronic cheque is to be drawn.

13. An electronic cheque method as claimed in claim 11, wherein the required data further comprises: the amount of the electronic cheque, a name of the issuer, and the electronic cheque date.

14. An electronic cheque method as claimed in claim 11, wherein prior to advising the machine of recipient of the required data, the cheque issuing server sends to the machine of the issuer full details of the electronic cheque for confirmation, the required data being sent by the cheque issuing server after receipt by the cheque issuing server of confirmation from the machine of the issuer.

15. An electronic cheque method as claimed in claim 14, wherein the full details of the electronic cheque comprise at least one selected from the group consisting of the date of the electronic cheque, the amount of the electronic cheque, the unique cheque code, the name of the recipient, the mobile ‘phone number of the recipient, and basic details of the account of the issuer at the bank on which the electronic cheque is to be drawn.

16. An electronic cheque system comprising:
a cheque issuing server residing within an issuing bank and configured to receive an electronic cheque request from a machine of an issuer,
the cheque issuing server also being configured to issue the electronic cheque and allocating and applying a unique cheque code to the electronic cheque to identify the electronic cheque;
the cheque issuing server further being configured to advise a machine of a recipient of required data of the electronic cheque, the required data comprising the unique cheque code;
the cheque issuing server additionally being configured to receive from the machine of the recipient a claim for credit of the electronic cheque amount, the claim being by reference to the unique cheque code
the claim further comprising details of an account of the recipient into which the electronic cheque amount is to be credited;
wherein, the cheque issuing server is configured to submit the electronic cheque for clearance to an automated clearance house after receiving the claim such that, upon clearance, a bank account of the issuer is debited and a bank account of the recipient is credited with the electronic cheque amount.

17. An electronic cheque system as claimed in claim 16, wherein the electronic cheque request comprises prescribed minimum data, the prescribed minimum data comprising at least one selected from the group consisting of a name of the recipient, the date, the amount of the electronic cheque, a number of a mobile ‘phone of the recipient, and basic details of the account of the issuer at the bank on which the electronic cheque is to be drawn.

18. An electronic cheque system as claimed in claim 16, wherein the required data further comprises: the amount of the electronic cheque, a name of the issuer, and the electronic cheque date.

19. An electronic cheque system as claimed in claim 16, wherein prior to advising the machine of recipient of the required data, the cheque issuing server sends to the machine of the issuer full details of the electronic cheque for confirmation, the required data being sent by the cheque issuing server after receipt by the cheque issuing server of confirmation from the machine of the issuer.

20. An electronic cheque system as claimed in claim 19, wherein the full details of the electronic cheque comprise at least one selected from the group consisting of the date of the electronic cheque, the amount of the electronic cheque, the unique cheque code, the name of the recipient, the mobile ‘phone number of the recipient, and basic details of the account of the issuer at the bank on which the electronic cheque is to be drawn.

21. An electronic cheque system as claimed in claim 16, wherein the cheque issuing server stores data relating to the electronic cheque in folders of the issuer, the recipient and the issuing bank.

22. An electronic cheque system as claimed in claim 21, wherein the issuer has access to data stored in the issuer's folder; the recipient has access to data stored in the recipient's folder; and the issuing bank has access to date stored in the issuing bank's folder.
